(19) United States
(12) Patent Application Publication
(10) Pub. No.: US 2026/0356295 A1
(43) Pub. Date: Nov. 12, 2026

(54) FIREARM MAGAZINE HOLDER FOR VEHICLE STORAGE

(71) Applicant: William Rodney Quinn, Lewisburg, TN (US)

(72) Inventor: William Rodney Quinn, Lewisburg, TN (US)

(73) Assignee: UpAmmo LLC, Lewisburg, TN (US)

(21) Appl. No.: 19/672,680

(22) Filed: May 10, 2026

Related U.S. Application Data
(60) Provisional application No. 63/803,094, filed on May 9, 2025.

(51) Int. Cl. B60R 7/14; B60R 7/04; F42B 39/28

(52) U.S. Cl. CPC B60R 7/14; B60R 7/046; F42B 39/28

(57) ABSTRACT

A firearm accessory holder system is disclosed. The system includes a container body configured for a storage location and an insert seated in the container body. The insert includes an accessory-receiving aperture configured to receive a firearm magazine or other firearm accessory. The aperture includes a central region, lobes extending outwardly from the central region, and inwardly projecting portions configured to contact the firearm accessory. In some embodiments, the inwardly projecting portions define spaced compression regions that elastically deflect when the firearm accessory is received. The insert may include a retaining protrusion received in a retaining opening of the container body to resist removal of the insert when the firearm accessory is withdrawn. The container body may include a mechanical interlock configured to couple to an adjacent container body to form a modular storage arrangement.

### REFERENCE TO RELATED APPLICATIONS

This application is a non-provisional which claims the benefit of the filing date of U.S. Provisional Application Ser. No. 63/803,094 and filed May 9, 2025, the subject matter of which is incorporated herein by reference.

### CROSS-REFERENCES

Not applicable.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISK

Not applicable.

### TECHNICAL FIELD

The present disclosure relates to the field of firearm accessories and storage solutions, and more particularly, to the field of firearm magazine holders designed for securing, retaining and providing accessibility said firearm accessories within a compartment of a vehicle.

### BACKGROUND OF THE INVENTION

Firearm users, including law enforcement personnel, military personnel, security professionals, and civilian firearm owners, may require a secure and accessible means for storing firearm magazines and related firearm accessories in a variety of environments. Such environments may include vehicles, safes, lockboxes, nightstands, drawers, storage trays, range bags, cabinets, and other compartments or support locations. In many circumstances, additional magazines are placed loosely within a general-purpose storage area that is not specifically configured to retain the magazines in a fixed orientation or in a readily accessible position.

General-purpose storage locations are often poorly adapted for firearm magazine retention. For example, vehicle door pockets, center consoles, glove compartments, drawers, shelves, safe interiors, and nightstand compartments may vary widely in size, depth, contour, and available internal volume. Because these locations are not typically designed to retain firearm magazines, magazines placed loosely within them may shift, rotate, tip over, rattle, contact surrounding objects, or become buried among other items. This can make the magazines difficult to locate and retrieve and may increase the likelihood of unintended displacement during movement, vibration, impact, or repeated opening and closing of the storage location.

Some conventional magazine storage systems employ rigid mounting brackets, straps, panels, clips, or adhesive-based retention methods to affix magazines to a surface. While such designs may provide some level of retention, they often require permanent or semi-permanent installation, such as drilling holes, applying adhesives, attaching hardware, or otherwise modifying the supporting structure. These approaches can reduce transferability between locations, limit repositioning of the holder, and may leave visible marks or damage after removal. Such systems may also be poorly suited for use in storage compartments that have limited space, curved or irregular surfaces, or user-specific organizational requirements.

Other known magazine carriers are designed for on-person use, including belt-mounted pouches, pocket carriers, tactical vest carriers, and concealed magazine holders. Although these devices may be useful for carrying a magazine on a user's body or equipment, they are not necessarily adapted to organize or retain one or more magazines within a vehicle compartment, safe, drawer, nightstand, lockbox, or other storage location. Such carriers may occupy excessive space, may not maintain a stable position when placed in a compartment, and may not provide a modular storage arrangement that conforms to the available storage area.

Conventional rigid magazine holders and compartmentalized organizers also present limitations. Rigid compartments may not accommodate variations in magazine dimensions, base plate configurations, surface profiles, or manufacturing tolerances. If a compartment is oversized, the magazine may rattle or move. If the compartment is undersized, insertion and withdrawal may require excessive force. Rigid walls may also fail to provide localized, adaptive compression against different portions of a magazine. As a result, such holders may not provide an appropriate balance between secure retention and rapid accessibility.

Prior storage approaches also often lack effective modularity. A user may wish to store a single magazine, multiple magazines, magazines of different types, or other firearm accessories in a selected arrangement. Fixed organizers may not permit selective expansion, reconfiguration, or coupling of adjacent holder modules. Separate loose containers may shift relative to one another, tilt, or separate. Without a mechanical interlock between adjacent modules, multiple holders placed in the same storage area may not maintain a stable and repeatable arrangement.

Another issue with conventional retention systems is that inserts, liners, or foam components may become dislodged from a supporting container when a retained magazine is withdrawn. This problem may occur where a resilient insert grips a magazine with sufficient friction to retain the magazine. When the magazine is removed, the frictional engagement between the magazine and the insert may pull the insert upwardly or outwardly from the container. Adhesive retention, simple friction fits, or unkeyed insert arrangements may degrade over time or may not reliably resist removal of the insert during repeated insertion and withdrawal cycles.

Prior magazine retention systems may also fail to provide an aperture geometry that both stabilizes a magazine and permits convenient retrieval. A simple circular, rectangular, or oversized opening may not engage the exterior surfaces of a magazine at controlled locations. Conversely, an overly tight opening may resist insertion and withdrawal. Existing holders may not provide inwardly tapered wall portions, narrowed waist regions, or spaced compression regions arranged to elastically deflect around a magazine while maintaining the magazine in a desired orientation.

In addition, many prior systems leave magazines exposed or poorly isolated from surrounding objects. Exposed magazines can contact other articles in the storage location, generate noise, accumulate dust or debris, or become displaced due to movement, vibration, impact, or repeated access to the storage location. Systems that fully enclose magazines may reduce exposure but can also slow access by requiring additional opening, unlatching, or removal steps. Thus, prior devices often do not provide an effective combination of retention, accessibility, compactness, modularity, and adaptability.

Accordingly, there remains a need for a firearm magazine holder assembly configured for placement in a storage location, including but not limited to a vehicle storage compartment, safe, lockbox, drawer, nightstand, tray, or cabinet, and having a resilient insert that can receive and retain a magazine through localized compression while permitting convenient withdrawal. There is also a need for a retention insert system that resists removal of the insert from the container when a magazine is withdrawn. There is a further need for a modular firearm accessory holder system having mechanically interlocking container bodies that can be selectively coupled to provide a configurable storage arrangement.

### BRIEF SUMMARY OF THE INVENTION

A firearm magazine holder assembly and system is disclosed. This Summary is provided to introduce a selection of disclosed concepts in a simplified form that are further described below in the Detailed Description, including the drawings provided. This Summary is not intended to identify key features or essential features of the claimed subject matter. Nor is this Summary intended to be used to limit the claimed subject matter's scope.

In one embodiment, a firearm magazine holder assembly is disclosed. The firearm magazine holder assembly includes a container body sized for placement in a vehicle door pocket, the container body comprising a bottom wall, a plurality of sidewalls extending upwardly from the bottom wall, and an open upper side. An insert-receiving opening is disposed along at least one sidewall of the plurality of sidewalls of the container body. A resilient insert is seated in the insert-receiving opening and includes a receiving aperture. The receiving aperture includes a central region and a plurality of lobes extending outwardly from the central region.

Additional aspects of the disclosed embodiment will be set forth in part in the description which follows, and in part will be obvious from the description, or may be learned by practice of the disclosed embodiments. The aspects of the disclosed embodiments will be realized and attained by means of the elements and combinations particularly pointed out in the appended claims. It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute part of this specification, illustrate embodiments of the disclosure and together with the description, explain the principles of the disclosed embodiments. The embodiments illustrated herein are presently preferred, it being understood, however, that the disclosure is not limited to the precise arrangements and instrumentalities shown, wherein:

FIG. 1 is a perspective view of a firearm magazine holder assembly and system receiving a firearm magazine, according to an example embodiment;

FIG. 2 is a side view thereof, according to an example embodiment;

FIG. 3 is a front view thereof, according to an example embodiment;

FIG. 4 is a rear view thereof, according to an example embodiment;

FIG. 5 is a bottom view thereof, according to an example embodiment;

FIG. 6 is a top perspective view of a container body of the firearm magazine holder assembly and system, according to an example embodiment;

FIG. 7 is a bottom perspective view thereof, according to an example embodiment;

FIG. 8 is a perspective view of an insert of the firearm magazine holder assembly and system, according to an example embodiment;

FIG. 9 is a top view thereof showing a receiving aperture having a generally cruciform profile, according to an example embodiment;

FIG. 10 is a perspective view of a modular firearm accessory holder system including adjacent container bodies coupled together, according to an example embodiment;

FIG. 11 is an exploded perspective view thereof, according to an example embodiment; and

FIG. 12 is a perspective view of the modular firearm accessory holder system positioned in a vehicle door pocket, according to an example embodiment.

Like reference numerals refer to like parts throughout the various views of the drawings. The figures are drawn to scale.

### DETAILED DESCRIPTION

The following detailed description refers to the accompanying drawings. Whenever possible, the same reference numbers are used in the drawings and the following description to refer to the same or similar elements. While disclosed embodiments may be described, modifications, adaptations, and other implementations are possible. For example, substitutions, additions, or modifications may be made to the elements illustrated in the drawings, and the methods described herein may be modified by substituting reordering or adding additional stages or components to the disclosed methods and devices. Accordingly, the following detailed description does not limit the disclosed embodiments. Instead, the proper scope of the disclosed embodiments is defined by the appended claims.

The disclosed embodiments improve upon the problems with the prior art by providing a system that securely and accessibly retains firearm magazines and other firearm accessories in a storage location without requiring permanent installation or substantial modification of the storage location. In one aspect, the system includes a container body configured to support a resilient insert having a receiving aperture with a central region and a plurality of lobes extending outwardly from the central region. The receiving aperture may include tapered wall portions, narrowed waist regions, or inwardly projecting protrusions configured to contact exterior surfaces of a firearm magazine or other firearm accessory at spaced compression regions. The resilient insert may elastically deflect at the spaced compression regions to provide adaptive retention while permitting convenient insertion and withdrawal of the firearm magazine or other firearm accessory. In another aspect, the resilient insert may include a retaining protrusion received in a retaining opening of the container body to resist removal of the insert from the container body when the firearm magazine or other firearm accessory is withdrawn. In a further aspect, the container body may include a connector, such as a dovetail profile or other mechanical interlock, configured to couple the container body to an adjacent container body, thereby enabling a modular storage arrangement that may be selectively configured for different storage locations, magazine quantities, accessory types, and user preferences.

The disclosed embodiments further improve upon the problems with the prior art by allowing the container body, the insert, or both the container body and the insert to conform to storage locations having different sizes, shapes, depths, or contours. Prior firearm magazine holders often rely on rigid housings, fixed mounting brackets, straps, adhesives, or vehicle-specific mounting structures, which can limit transferability between storage locations and may require modification of the supporting structure. In contrast, in certain embodiments, the container body may include resilient sidewalls, flexible wall sections, compressible exterior surfaces, or deformable connector portions configured to compress, flex, or otherwise elastically deform when the system is positioned within a vehicle door pocket, console compartment, drawer, safe compartment, nightstand compartment, tray, or other storage location. The resiliency of the container body, the insert, or both may allow the system to frictionally engage surrounding compartment walls while accommodating dimensional variations between different storage locations. In this manner, the system may provide a secure and adaptable fit without requiring permanent mounting hardware, adhesives, drilling, or a storage-location-specific configuration.

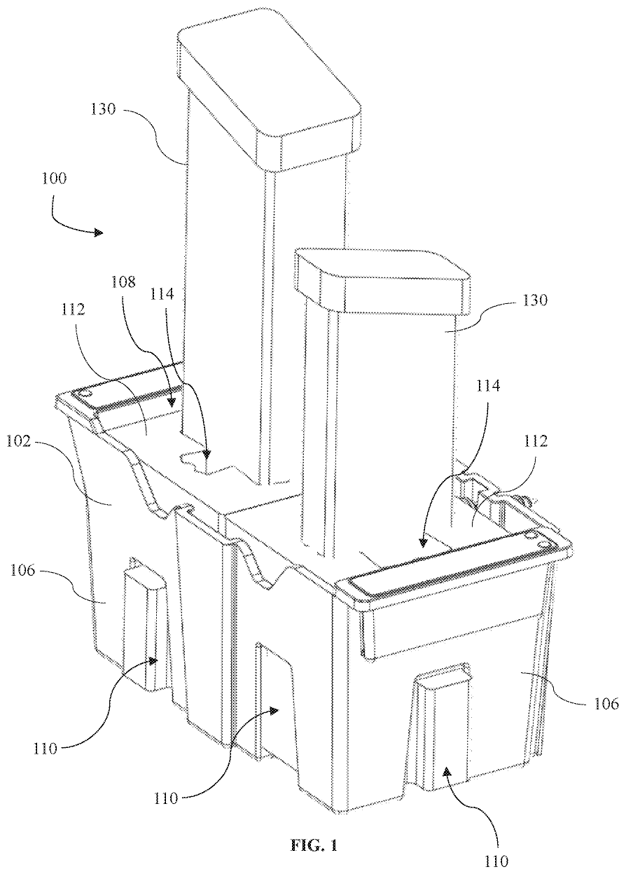

Referring now to the Figures, and initially to FIGS. 1-5, a firearm magazine holder assembly 100 is shown according to an example embodiment. The firearm magazine holder assembly 100 may generally include any structure configured to receive, organize, retain, support, position, or otherwise hold one or more firearm magazines 130 or other firearm accessories in a selected storage location. In some embodiments, the storage location may include a vehicle door pocket, vehicle console, glove compartment, safe, lockbox, drawer, nightstand compartment, tray, cabinet, range bag, or other compartment, recess, support surface, or storage region. The firearm magazine holder assembly 100 may be configured to maintain the one or more firearm magazines 130 in a generally upright, accessible, and repeatable position while reducing movement, rattling, tipping, or unintended displacement of the firearm magazines 130 relative to the storage location.

In the illustrated embodiment, the firearm magazine holder assembly 100 includes a container body 102 and one or more inserts 112 supported by the container body 102. The container body 102 may generally define a receptacle, housing, tray, frame, support body, carrier, or other structural body configured to receive or support one or more inserts 112 and one or more firearm magazines 130. In one example embodiment, the container body 102 includes a bottom wall 104, a plurality of sidewalls 106 extending upwardly from the bottom wall 104, and an open upper side 108 through which the firearm magazines 130 may be inserted into and withdrawn from the firearm magazine holder assembly 100. The plurality of sidewalls 106 may cooperate with the bottom wall 104 to define an interior cavity, storage volume, or receiving region for supporting portions of the firearm magazines 130 and for positioning the one or more inserts 112 relative to the firearm magazines 130. The open upper side 108 may permit a user to access the firearm magazines 130 without opening a lid, releasing a strap, or performing a separate unlocking action.

In one embodiment, the plurality of sidewalls 106 may define an upper wall portion, rim portion, ledge portion, or sidewall-adjacent upper structure positioned proximate to the open upper side 108 of the container body 102. The upper wall portion may extend at least partially around an upper perimeter of the container body 102 and may help define, support, or frame the open upper side 108. In such an embodiment, one or more insert-receiving openings 110 may be formed at a lower portion of one or more of the plurality of sidewalls 106, below the upper wall portion, so that portions of the one or more inserts 112, such as retaining protrusions 136, may extend into or through the one or more insert-receiving openings 110 when the one or more inserts 112 is seated in the container body 102. During assembly, the one or more inserts 112 may be inserted through the open upper side 108 and pressed downwardly into the container body 102 until the one or more inserts 112 is seated relative to the upper wall portion and the retaining protrusions 136 engage the one or more insert-receiving openings 110. This configuration may allow the open upper side 108 to provide access for installing, removing, or replacing the one or more inserts 112, while the lower-positioned one or more insert-receiving openings 110 mechanically retain the one or more inserts 112 against lifting or withdrawal during removal of a firearm magazines 130 or other accessory from the receiving aperture 114.

The container body 102 may be sized and shaped to fit within a selected storage location. For example, as shown in FIGS. 1-4, the container body 102 may have an elongated form factor suitable for receiving multiple inserts and, accordingly, multiple firearm magazines 130 in a side-by-side arrangement. In other embodiments, the container body 102 may be sized to receive a single insert, and as such, a single firearm magazine 130, or may be sized to receive multiple inserts and accessories, such as two firearm magazines 130, or more than two firearm magazines 130. The container body 102 may have a rectangular, tapered, curved, irregular, or compartment-conforming outer profile. In certain embodiments, one or more of the plurality of sidewalls 106 may be angled, bowed, stepped, ribbed, flared, or otherwise shaped to conform to or frictionally engage a vehicle door pocket, drawer wall, safe wall, tray wall, or other surrounding structure. In this manner, the container body 102 may provide a stable support platform for the firearm magazines 130 without requiring permanent mounting hardware, adhesives, drilling, or vehicle-specific brackets.

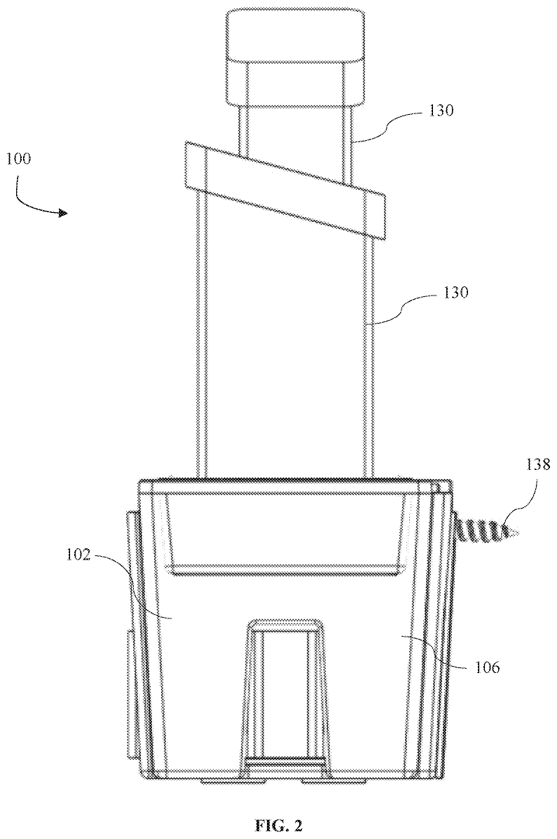

The one or more inserts 112 may generally include any component configured to receive, guide, cushion, grip, align, or retain a firearm magazine 130 or other firearm accessory relative to the container body 102. In some embodiments, the one or more inserts 112 may be a resilient insert, a compressible insert, a foam insert, an elastomeric insert, a polymer insert, a liner, a cartridge, a sleeve, a bushing, a collar, or another component supported by the container body 102. As shown in FIGS. 1 and 2, a firearm magazine 130 may extend through or into an accessory-receiving aperture or receiving aperture 114 of the one or more inserts 112. The receiving aperture 114 may generally include an opening, passage, through-hole, slot, recess, or aperture configured to receive at least a portion of the firearm magazine 130. In one example embodiment, the receiving aperture 114 is sized and shaped to receive a portion of the firearm magazine 130 while the one or more inserts 112 resiliently engages exterior surfaces of the firearm magazine 130 to resist movement of the firearm magazine 130 relative to the container body 102.

The one or more inserts 112 interacts with the container body 102 by being seated, received, captured, retained, or otherwise supported in a one or more insert-receiving openings 110 of the container body 102. The one or more insert-receiving openings 110 may generally include any opening, seat, recess, slot, cavity, support region, or receiving feature configured to receive at least a portion of the one or more inserts 112. In some embodiments, at least a portion of the one or more inserts 112 may extend past or through a one or more of the plurality of sidewalls 106 of the container body 102 proximate to the one or more insert-receiving openings 110. In the illustrated embodiment, the one or more insert-receiving openings 110 is disposed along at least one or more of the plurality of sidewalls 106 of the container body 102 and supports the one or more inserts 112 adjacent the open upper side 108. By positioning the one or more inserts 112 relative to the open upper side 108, the firearm magazine holder assembly 100 can retain an upper or intermediate portion of the firearm magazine 130 while allowing the firearm magazine 130 to remain accessible for withdrawal. This arrangement may improve over prior art storage systems that either allow magazines to rest loosely within a compartment or require straps, flaps, clips, or enclosed compartments that can slow retrieval.

The firearm magazine 130 may generally include any ammunition magazine, cartridge feeding device, ammunition storage device, firearm accessory, tool, or similarly shaped article configured to be received by the firearm magazine holder assembly 100. In the illustrated embodiment, the firearm magazine 130 is shown as an elongated magazine having an exterior profile received through the receiving aperture 114 of the one or more inserts 112. The firearm magazine 130 may be held in a generally upright orientation by engagement between the one or more inserts 112 and the exterior surfaces of the firearm magazine 130, and by support from the container body 102. In some embodiments, different firearm magazines 130 having different widths, lengths, curvature, base plate shapes, or exterior configurations may be received by the same or different one or more inserts 112. The firearm magazine holder assembly 100 may therefore accommodate a range of magazine geometries without requiring a dedicated rigid pocket for each magazine type.

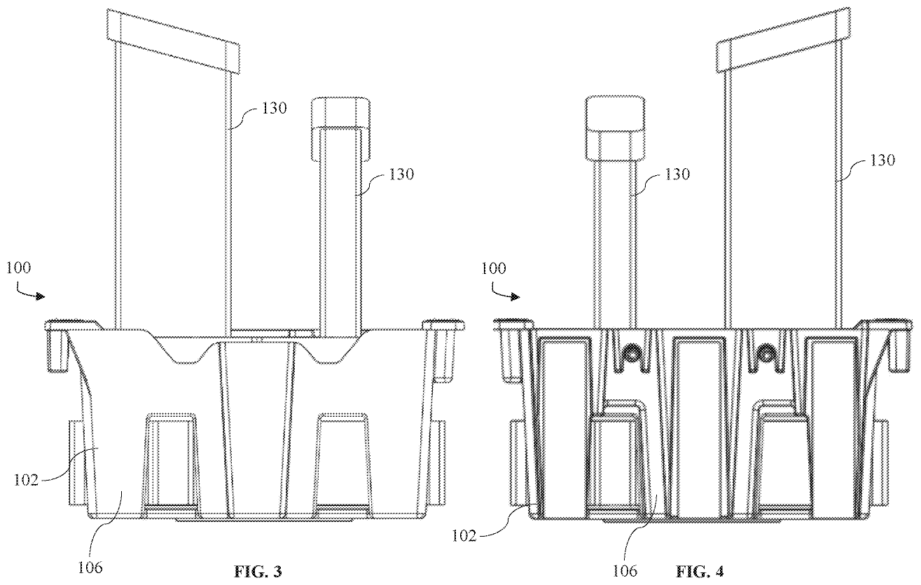

As shown in FIGS. 3 and 4, the firearm magazine holder assembly 100 may support multiple firearm magazines 130 at spaced positions along the container body 102. The plurality of sidewalls 106 may provide lateral support, structural stiffness, and containment around lower portions of the firearm magazines 130, while the one or more inserts 112 may provide localized engagement near the open upper side 108. In some embodiments, the container body 102 may include one or more inserts 112 for each firearm magazine 130. In other embodiments, a single insert of the one or more inserts 112 may define multiple receiving apertures 114, or one or more inserts 112 may be arranged in one or more rows. The spacing between adjacent receiving apertures 114 may be selected to reduce interference between firearm magazines 130, facilitate grasping of an individual magazine, and maintain a consistent orientation of the magazines within the storage location.

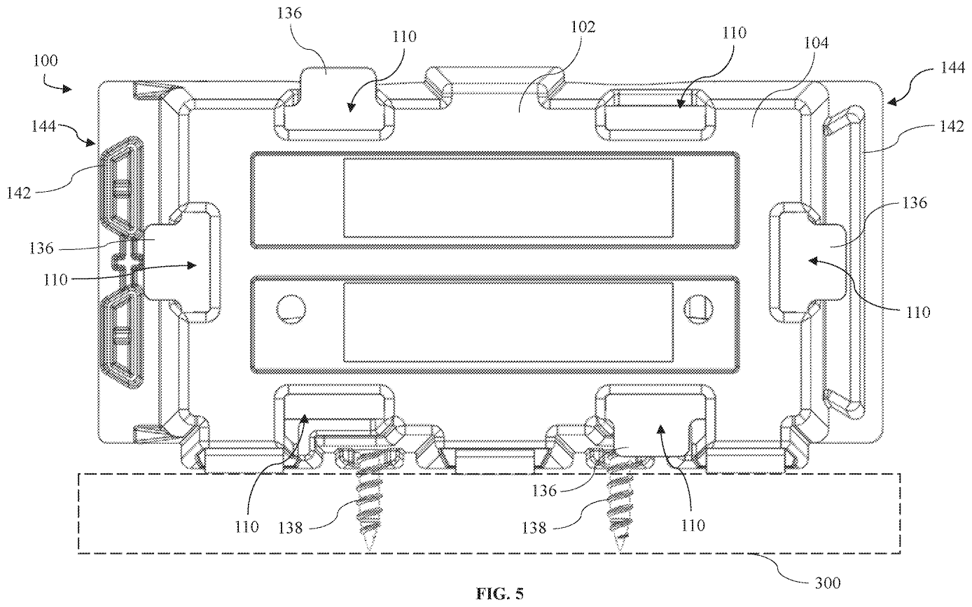

As shown in FIG. 5, the container body 102 may include one or more features disposed along or accessible from the bottom wall 104. The bottom wall 104 may generally define a lower support surface, base, floor, mounting wall, or structural portion of the container body 102 configured to support the firearm magazine holder assembly 100 within a storage location. In the illustrated embodiment, the bottom wall 104 includes a plurality of one or more insert-receiving openings 110 positioned about the container body 102 and configured to receive corresponding portions of one or more inserts 112. The one or more insert-receiving openings 110 may be located along sidewall-adjacent regions, end regions, corner regions, or other portions of the container body 102 so that the inserts 112 may be seated, keyed, captured, or otherwise retained relative to the container body 102. The container body 102 may further include the one or more insert-receiving openings 110 configured to receive corresponding retaining protrusions 136 of the inserts 112. The one or more insert-receiving openings 110 may cooperate with the retaining protrusions to resist lifting, peeling, or removal of the inserts 112 from the container body 102 when a firearm magazine 130 is withdrawn. The bottom wall 104 may also include one or more fasteners 138, fastener openings, bosses, pads, ribs, channels, recesses, or mounting regions configured to secure, reinforce, or stabilize the container body 102 relative to a support surface or secondary wall member. By providing insert-retention and mounting features accessible from or visible along the bottom wall 104, the firearm magazine holder assembly 100 may improve over prior storage systems that rely only on friction-fit liners, adhesives, or loose inserts that can become dislodged during repeated use.

The firearm magazine holder assembly 100 may improve upon prior art devices by combining accessible open-top storage with resilient retention. Conventional vehicle and compartment storage approaches may allow magazines to shift, rattle, tip, or become hidden among other objects. Conventional mounted carriers may require fixed brackets, straps, adhesives, or fasteners that limit transferability and require modification of the surrounding structure. In contrast, the firearm magazine holder assembly 100 may be placed in a storage location and may retain one or more magazines 130 through engagement between the one or more inserts 112 and the magazine 130, optionally with frictional or conforming engagement between the container body 102 and the surrounding compartment. This may allow the firearm magazine holder assembly 100 to be installed, removed, repositioned, or transferred without permanent modification of the storage location.

The container body 102 and the one or more inserts 112 may be made from the same or different materials depending on the desired retention, flexibility, durability, and manufacturing method. The container body 102 may be formed from a polymer, elastomer, thermoplastic, thermoset, composite, metal, fiber-reinforced material, foam, rubber, silicone, urethane, nylon, polypropylene, polyethylene, acrylonitrile butadiene styrene, polycarbonate, thermoplastic elastomer, or combinations thereof. In certain embodiments, the container body 102 may be formed by injection molding, additive manufacturing, casting, machining, thermoforming, compression molding, stamping, cutting, or another manufacturing process. The one or more inserts 112 may be formed from a resilient or compressible material, including foam, rubber, silicone, urethane, elastomeric polymer, thermoplastic elastomer, resilient plastic, layered material, or combinations thereof. In some embodiments, the one or more inserts 112 may be cut, molded, die-cut, waterjet-cut, laser-cut, cast, printed, or otherwise formed to define the receiving aperture 114.

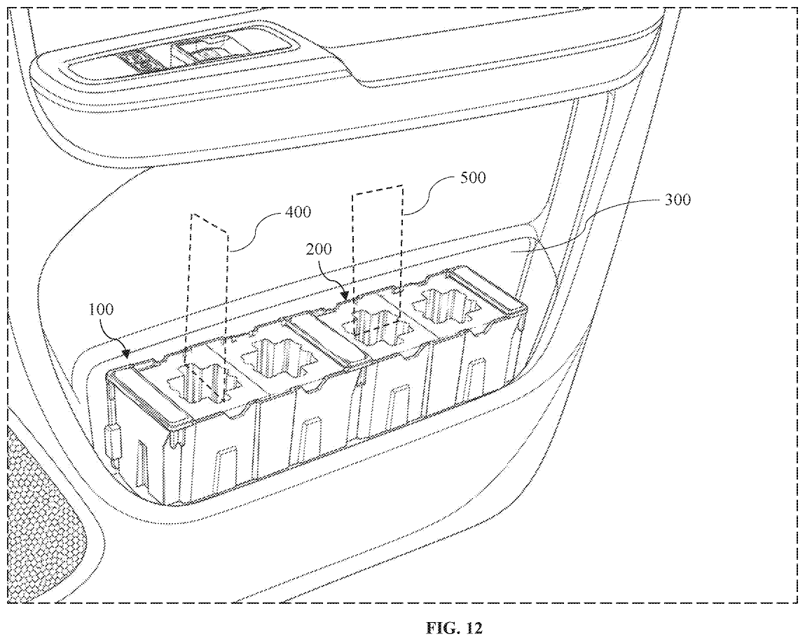

As shown in FIG. 5, and in some embodiments further shown in FIG. 12, the firearm magazine holder assembly 100 may include one or more fasteners 138 configured to secure, stabilize, or position the container body 102 relative to a secondary wall member 300, support surface, compartment wall, mounting plate, bracket, or other adjacent structure. The fasteners 138 may generally include any mechanical fastening element, including a screw, bolt, rivet, pin, clip, snap-fit member, threaded insert, hook, latch, clamp, or other coupling structure. In the illustrated embodiment, the fasteners 138 may extend through or adjacent a portion of the container body 102 to attach the container body 102 to the secondary wall member 300 in an assembled configuration. The fasteners 138 may interact with the container body 102 by resisting movement, lifting, tilting, or separation of the container body 102 relative to the secondary wall member 300 while the firearm magazine 130 is inserted into or withdrawn from the one or more inserts 112. This arrangement may improve over prior storage systems by permitting a more secure installed configuration when desired, while still allowing the container body 102 and one or more inserts 112 to provide accessible magazine retention. In alternative embodiments, the fasteners 138 may be removable, tool-less, threaded, integrally formed, concealed, countersunk, positioned along the bottom wall 104, positioned along one or more of the plurality of sidewalls 106, or omitted where frictional engagement, compression pads, mechanical interlocks, or other retention features are sufficient to hold the firearm magazine holder assembly 100 in place.

Although FIGS. 1-5 show the firearm magazine holder assembly 100 receiving firearm magazines 130, the disclosed configuration is not limited to the illustrated magazine geometry or to firearm magazines exclusively. In other embodiments, the firearm magazine holder assembly 100 may receive firearm accessories, ammunition carriers, tools, flashlights, suppressor accessories, cleaning components, medical components, electronic devices, or other articles having exterior surfaces suitable for engagement by the one or more inserts 112. Likewise, although the firearm magazine holder assembly 100 illustrated is shown with multiple magazine positions, the firearm magazine holder assembly 100 may be provided as a single-position holder, a multi-position holder, a modular holder, or a holder configured to couple with one or more adjacent holders.

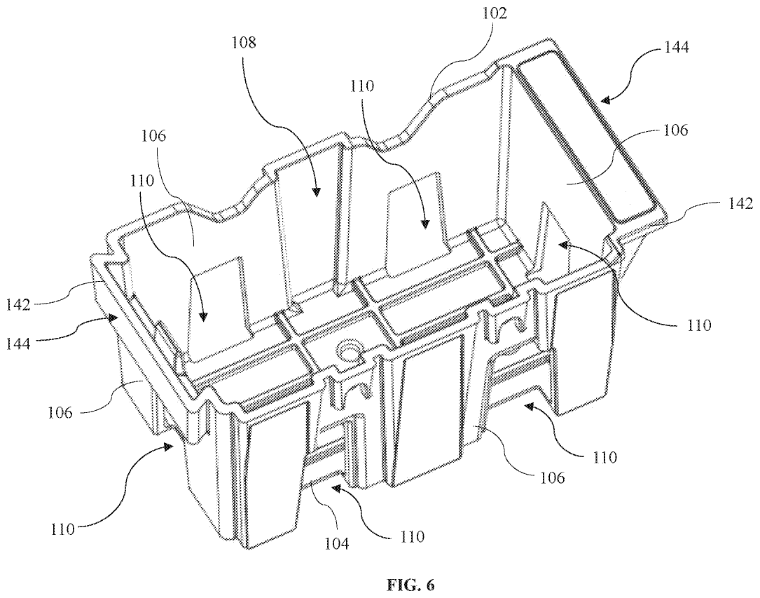

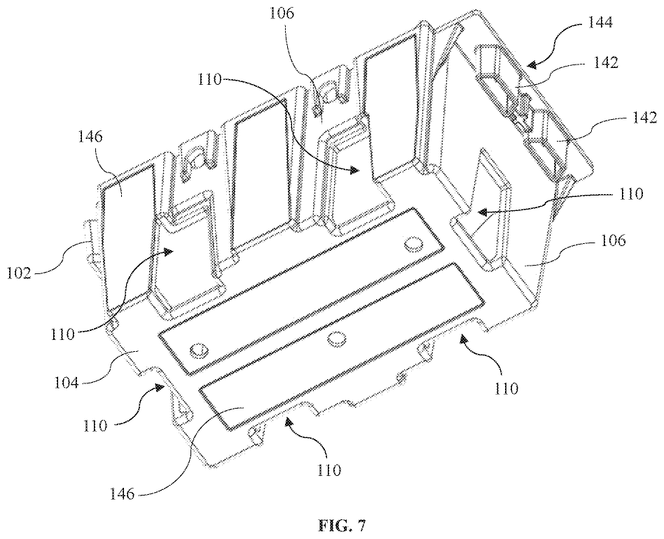

Referring now to FIGS. 6 and 7, the container body 102 is shown apart from the inserts 112 and firearm magazines 130 to further illustrate structural features of the container body 102. As discussed above, the container body 102 may generally define a support body configured to receive one or more inserts 112 and to position the inserts 112 relative to one or more firearm magazines 130 or other firearm accessories. In the illustrated embodiment, the container body 102 includes the bottom wall 104, the plurality of sidewalls 106 extending from the bottom wall 104, and the open upper side 108. The plurality of sidewalls 106 may define a perimeter structure around the open upper side 108 and may include one or more insert-receiving openings 110 positioned to receive, support, or expose corresponding portions of the inserts 112 when the inserts 112 are assembled with the container body 102.

The one or more insert-receiving openings 110 may be provided at different locations of the container body 102 to allow the inserts 112 to be retained from multiple directions. For example, as shown in FIGS. 6 and 7, the one or more insert-receiving openings 110 may be formed along plurality of sidewalls 106, end portions 144, lower regions adjacent the bottom wall 104, upper regions adjacent the open upper side 108, or combinations thereof. In certain embodiments, the one or more insert-receiving openings 110 may function as windows, slots, pockets, recesses, or keyed receiving regions that receive portions of the inserts 112 or permit protrusions of the inserts 112 to extend through the container body 102. This arrangement may allow the one or more inserts 112 to be mechanically located relative to the container body 102 rather than relying solely on adhesive bonding or surface friction. Accordingly, the one or more insert-receiving openings 110 may help resist displacement of the one or more inserts 112 during repeated insertion and withdrawal of a firearm magazine 130.

The container body 102 may further include one or more connectors 142 disposed at or proximate to an end portion 144 of the container body 102. The connector 142 may generally include any coupling feature, alignment feature, interlock, rail, channel, projection, recess, dovetail feature, tongue-and-groove feature, snap-fit feature, latch feature, hook feature, keyed surface, or other structure configured to mechanically engage a corresponding feature of another component. In the illustrated embodiment, the connector 142 is positioned along an exterior portion of the container body 102 at the end portion 144 and is configured to couple the container body 102 to an adjacent container body, such as the adjacent second container body 200. The end portions 144 may generally include an end wall, terminal sidewall portion, lateral end region, outer side surface, or other terminal portion of the container body 102 that supports or defines the connector 142.

In one example embodiment, the connector 142 may define a mechanical interlock configured to mate with a complementary mechanical interlock of an adjacent container body. In more specific embodiments, the connector 142 may include a dovetail profile configured to slidably engage a complementary dovetail profile of the adjacent container body. The connector 142 may thereby permit adjacent container bodies to be assembled in a side-by-side, end-to-end, stacked, or otherwise modular arrangement. The connector 142 may interact with the remainder of the system by maintaining relative alignment between adjacent container bodies and by resisting lateral separation, tilting, or shifting during use. This may improve over prior storage organizers that use independent loose containers or fixed unitary trays by allowing a user to selectively configure the number and arrangement of holder modules for a particular storage location or use case.

In the illustrated embodiment, the connector 142 may include a first connector portion having a generally bucket-shaped, channel-shaped, socket-shaped, or receptacle-shaped configuration and a second connector portion having a downwardly extending interlock projection. The first connector portion may define an upwardly open receiving channel, pocket, socket, or receptacle configured to receive the downwardly extending interlock projection of an adjacent container body. In some embodiments, the interlock projection may have a dovetail profile, T-shaped profile, keyed profile, hooked profile, tongue profile, rail profile, tapered profile, undercut profile, or other mechanical interlock geometry configured to engage a complementary connector portion. The upwardly open configuration may allow the adjacent container body to be lowered into engagement with the connector 142 and may capture the interlock projection to resist lateral separation between adjacent container bodies. The second connector portion may be positioned at an end portion 144 of the container body 102 that is vertically offset, raised, or elevated relative to an opposing end portion 144 of the container body 102. In this configuration, the downwardly extending interlock projection may extend from the elevated end portion 144 toward the lower end portion of an adjacent container body when the adjacent container bodies are coupled together. The vertical offset between the one or more end portions 144 may allow the coupled container bodies to nest, overlap, or interfit without causing one container body to be lifted relative to the other. For example, if complementary connector portions were positioned at the same height, engagement between the connector portions could create an interference condition that prevents the bottom wall 104 of adjacent container bodies from sitting substantially flush against a support surface. By elevating one end portion 144 relative to the another end portion 144, the connector 142 can provide mechanical interlocking engagement while permitting adjacent container bodies to rest in a common plane or to sit substantially flush within a storage location.

In certain embodiments, the connector 142 may be integrally formed with the container body 102. For example, the connector 142 and the end portion 144 may be molded, printed, cast, machined, or otherwise formed as a unitary portion of the container body 102. In other embodiments, the connector 142 may be a separate component attached to the container body 102 by adhesive, welding, fasteners, snap-fit engagement, overmolding, press-fit engagement, or another coupling technique. The connector 142 may be formed from the same material as the container body 102 or from a different material selected to provide increased stiffness, wear resistance, flexibility, or retention force. In some embodiments, the connector 142 may be rigid to maintain alignment between adjacent modules. In other embodiments, the connector 142 may be resilient or partially deformable to permit snap-fit engagement, tolerance accommodation, or vibration damping.

As shown in FIG. 7, the container body 102 may include one or more compression pads 146 disposed along an exterior surface of the container body 102. The compression pads 146 may generally include protrusions, ribs, pads, bosses, feet, rails, raised surfaces, resilient members, textured regions, or other exterior engagement features configured to contact a surrounding storage location. In some embodiments, the compression pads 146 may compress, deflect, or frictionally engage a wall, floor, side surface, or contour of a vehicle door pocket, console, drawer, safe compartment, tray, cabinet, or other storage location. The compression pads 146 may improve fit across different storage environments by accommodating dimensional variation between compartments and reducing looseness, rattling, or sliding of the container body 102. In this manner, the compression pads 146 may provide an adaptable, non-permanent retention mechanism that avoids reliance on vehicle-specific brackets, adhesives, or permanent modifications.

The container body 102 may include additional structural features configured to provide strength, weight reduction, manufacturability, or positional stability. For example, the plurality of sidewalls 106 may include ribs, recesses, cutouts, reinforcing panels, tapered surfaces, rounded corners, chamfers, flanges, ledges, or thickened regions. Such features may reduce material usage while maintaining sufficient rigidity, may allow the container body 102 to flex locally without failure, and may provide clearance for magazines 130, inserts 112, fasteners 138, or adjacent structures. The bottom wall 104 may include raised regions, recessed regions, mounting surfaces, drainage openings, fastener bosses, or reinforcement members. These features may be selected based on the intended storage environment, manufacturing process, desired flexibility, and desired retention characteristics.

In alternative embodiments, the container body 102 may omit the connector 142, omit the compression pads 146, or include different numbers, shapes, or locations of such features. For example, a single container body 102 may be used independently without being coupled to another container body. In other embodiments, multiple connectors 142 may be positioned on opposite end portions 144, along plurality of sidewalls 106, or along the bottom wall 104 to permit modular coupling in multiple directions. Similarly, the compression pads 146 may be positioned on exterior sidewalls, end portions, bottom surfaces, corners, or combinations thereof. The container body 102 may therefore be configured as a standalone holder, a modular holder, a friction-fit holder, a fastened holder, or a holder adapted for a particular storage location while remaining within the scope of the disclosure.

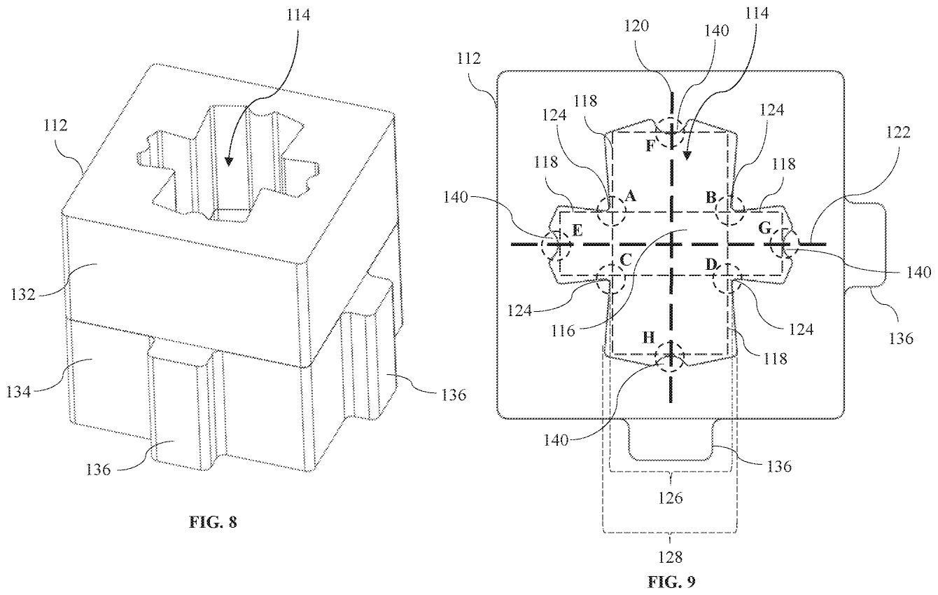

Referring now to FIGS. 8 and 9, the one or more inserts 112 is shown apart from the container body 102 to illustrate the receiving aperture 114 and retention features of the one or more inserts 112. The one or more inserts 112 may generally include a replaceable, removable, interchangeable, compressible, resilient, or otherwise accessory-engaging component configured to be seated in the container body 102 and to receive at least a portion of a firearm magazine 130 or other firearm accessory. The one or more inserts 112 may define a receiving aperture 114 configured to guide, align, laterally support, frictionally engage, resiliently compress against, or otherwise retain an accessory relative to the firearm magazine holder assembly 100. In some embodiments, the one or more inserts 112 may be configured as a modular cartridge that can be selectively installed in and removed from the container body 102 so that different inserts 112 may be used with different magazine sizes, magazine geometries, accessory types, or desired retention forces.

In the illustrated embodiment, the one or more inserts 112 includes a first insert portion 132 and a second insert portion 134 disposed proximate to the first insert portion 132. The first insert portion 132 may generally include an upper insert body, accessory-engaging insert body, retention body, aperture-defining body, or first block portion of the one or more inserts 112. The second insert portion 134 may generally include a lower insert body, support body, spacer body, retaining body, base body, or second block portion of the one or more inserts 112. As shown in FIG. 8, the first insert portion 132 may be disposed above the second insert portion 134 in an assembled configuration. In this configuration, the first insert portion 132 may primarily define or surround the receiving aperture 114 that interfaces with the firearm magazine 130 or other accessory, while the second insert portion 134 may assist in positioning, stabilizing, spacing, or retaining the one or more inserts 112 relative to the container body 102. In other embodiments, the first insert portion 132 and the second insert portion 134 may be arranged side-by-side, nested, partially overlapping, interlocked, stacked, laminated, bonded, mechanically coupled, or otherwise disposed proximate to one another.

The first insert portion 132 and the second insert portion 134 may be attached to one another by adhesive, thermal bonding, ultrasonic welding, mechanical interlocking, stitching, overmolding, fasteners, friction-fit engagement, snap-fit engagement, tongue-and-groove engagement, or another coupling technique. In some embodiments, the first insert portion 132 and the second insert portion 134 may be formed as separate pieces that are assembled together. In other embodiments, the one or more inserts 112 may be formed as a single, unitary, monolithic, or integral block. Providing the one or more inserts 112 as multiple portions may allow the accessory-engaging portion of the one or more inserts 112 to be swapped, replaced, or selected independently from a lower retaining or support portion. For example, the first insert portion 132 may be replaced with another first insert portion having a different receiving aperture 114 to accommodate a different firearm magazine, tool, flashlight, accessory, or other article, while the second insert portion 134 may remain configured to interface with the same container body 102. This modular insert construction may improve over prior fixed holders by allowing a user or manufacturer to adapt the firearm magazine holder assembly 100 to different accessories without replacing the entire container body 102.

In some embodiments, the one or more inserts 112 may include the first insert portion 132 disposed proximate to the second insert portion 134, and at least one of the first insert portion 132 and the second insert portion 134 may include one or more retaining protrusions 136. The retaining protrusions 136 may extend outwardly from a side surface of the first insert portion 132, the second insert portion 134, or both, and may be configured to engage a corresponding one or more insert-receiving openings 110, retaining opening, recess, shoulder, lip, or other retention feature of the container body 102. In certain embodiments, at least one of the first insert portion 132 and the second insert portion 134 may further include a receiving section extending therein. The receiving section may generally define a through-opening, blind recess, cavity, passage, slot, channel, aperture segment, or other receiving feature configured to receive at least a portion of a firearm magazine 130, firearm accessory, tool, or other article. In one example embodiment, the first insert portion 132 may define at least part of the receiving aperture 114, while the second insert portion 134 may define a corresponding receiving section aligned with the receiving aperture 114 to permit the firearm magazine 130 or other article to extend into or through both insert portions. In other embodiments, the first insert portion 132 may provide the accessory-engaging receiving section and the second insert portion 134 may provide the retaining protrusions 136, thereby separating the accessory-retention function from the container-retention function. This arrangement may allow the one or more inserts 112 to be retained securely in the container body 102 while permitting the receiving section to be tailored for a selected accessory.

The receiving aperture 114 may generally include an opening, through-opening, passage, bore, slot, recess, aperture, or receiving region extending into or through the one or more inserts 112. In certain embodiments, the receiving aperture 114 may extend through the first insert portion 132, the second insert portion 134, or both. In other embodiments, the receiving aperture 114 may extend only partially through the one or more inserts 112 to define a blind recess or pocket. The receiving aperture 114 may have a cross-sectional profile selected to receive and retain a corresponding accessory.

For example, the receiving aperture 114 may have a generally cruciform profile, generally rectangular profile, generally square profile, generally circular profile, generally oval profile, generally polygonal profile, keyed profile, irregular profile, compound profile, or hybrid profile. In some embodiments, the one or more inserts 112 may include a single receiving aperture 114. In other embodiments, the one or more inserts 112 may include a plurality of receiving apertures 114, each of which may have the same or different size, shape, orientation, depth, or retention characteristic.

As shown in FIG. 9, the receiving aperture 114 may include a central region 116 and a plurality of lobes 118 extending outwardly from the central region 116. The central region 116 may generally include a central open area, intersection region, receiving region, or common region from which multiple aperture portions extend. The plurality of lobes 118 may generally include outwardly extending aperture portions, arms, receiving portions, recessed portions, or profile extensions that extend away from the central region 116. In the illustrated embodiment, the plurality of lobes 118 cooperate with the central region 116 to define a generally cruciform profile. The generally cruciform profile may include a first pair of opposed plurality of lobes 118 extending along a first axis 120 and a second pair of opposed plurality of lobes 118 extending along a second axis 122 transverse to the first axis 120. The first axis 120 and the second axis 122 may be orthogonal in some embodiments, as shown, or may intersect at another transverse angle in other embodiments.

The receiving aperture 114 may also define one or more generally rectangular cross-sectional profile portions. For example, the generally cruciform profile of FIG. 9 may be understood as including a first generally rectangular aperture portion extending along the first axis 120 and a second generally rectangular aperture portion extending along the second axis 122. The first and second generally rectangular aperture portions may intersect at the central region 116. In some embodiments, the first generally rectangular aperture portion and the second generally rectangular aperture portion may have different lengths, widths, aspect ratios, end shapes, or corner geometries. This configuration may allow the receiving aperture 114 to receive an accessory in a first orientation and also receive the same or a different accessory in a second orientation, including an orientation rotated about ninety degrees relative to the first orientation. In other embodiments, the generally rectangular profile portion may be only part of a larger aperture geometry and may cooperate with protrusions, relief regions, tapered regions, or other aperture features to accommodate different accessories.

Adjacent plurality of lobes 118 may be separated by tapered wall portions 124. The tapered wall portions 124 may generally include angled surfaces, sloped surfaces, converging wall portions, inwardly extending wall portions, transition wall portions, or compression-forming wall portions that extend inwardly toward the central region 116 or toward a path of an accessory received in the receiving aperture 114.

In the illustrated embodiment, the tapered wall portions 124 are disposed between adjacent plurality of lobes 118 and help define narrowed waist regions 126. The narrowed waist regions 126 may generally define constricted regions, reduced-width regions, throat regions, necked regions, pinch regions, interference regions, or compression regions of the receiving aperture 114. Each narrowed waist regions 126 may have a width, cross-sectional dimension, or opening dimension that is smaller than a corresponding width, cross-sectional dimension, or opening dimension of a wider portion 128 of at least one adjacent plurality of lobes 118. The wider portion 128 may generally define an expanded receiving region of the plurality of lobes 118 configured to accommodate a larger portion, side surface, corner, projection, or other exterior feature of the firearm magazine 130 or other accessory. The narrowed waist regions 126 may be dimensioned relative to the wider portion 128 to contact exterior surfaces of the firearm magazine 130 or other accessory received in the receiving aperture 114 and to create localized compression as the one or more inserts 112 elastically deflects.

The tapered wall portions 124 and narrowed waist regions 126 may interact with the accessory by providing localized retention rather than uniform rigid enclosure. For example, when a firearm magazine 130 is inserted into the receiving aperture 114, portions of the one or more inserts 112 adjacent the narrowed waist regions 126 may elastically deflect away from the firearm magazine 130 and then apply restoring forces against exterior surfaces of the firearm magazine 130. The restoring forces may define spaced compression regions A, B, C, and D around the firearm magazine 130. These spaced compression regions may stabilize the firearm magazine 130 in the receiving aperture 114 while still allowing a user to withdraw the firearm magazine 130 by applying a sufficient withdrawal force. This configuration may improve over rigid compartments that either fit loosely and allow rattling or fit tightly and impede access, because the one or more inserts 112 can provide compliant, localized, and repeatable retention.

The one or more inserts 112 may further include one or more further compression protrusions 140. These compression protrusions define a plurality of protrusions that project inwardly relative to the one or more inserts 112. The further compression protrusions 140 may generally include inwardly projecting protrusions, nubs, ribs, tabs, bumps, pads, ridges, scallops, constrictions, tapered projections, or other aperture features projecting inwardly relative to the receiving aperture 114. In the illustrated embodiment, the further compression protrusions 140 may be positioned along the receiving aperture 114 to define additional compression regions E, F, G, and H. The further compression protrusions 140 may be used independently of, or in combination with, the tapered wall portions 124 and narrowed waist regions 126. In some embodiments, the compression regions A-H may be arranged to contact different sides, edges, corners, flats, ridges, or curved surfaces of an accessory. By providing multiple compression regions, the one or more inserts 112 may retain accessories having different exterior profiles or orientations while reducing the need for a rigid custom-molded pocket for each accessory.

The cooperation between the tapered wall portions 124, narrowed waist regions 126, further compression protrusions 140, and the resilient material of the one or more inserts 112 may allow the receiving aperture 114 to accommodate accessories having different sizes, shapes, tolerances, and exterior profiles. For example, an accessory having a relatively larger cross-sectional dimension may cause greater elastic deflection of the one or more inserts 112 at one or more of the compression regions A-H, while an accessory having a relatively smaller cross-sectional dimension may still be contacted and retained by one or more of the narrowed waist regions 126 or further compression protrusions 140. The one or more inserts 112 may therefore provide a variable-fit retention interface in which portions of the receiving aperture 114 compress, flex, or deform locally to apply holding forces to the accessory without requiring the entire receiving aperture 114 to match the exact exterior profile of the accessory. This configuration may improve adaptability, reduce rattling, maintain accessibility, and permit a single of the one or more inserts 112 to retain multiple accessory types or sizes.

In some embodiments, the receiving aperture 114 may be configured to receive an accessory in multiple orientations. For example, an accessory may be received in a first configuration 400 (as shown in FIG. 12) aligned generally along the first axis 120, and an accessory may be received in a second configuration 500 (as shown in FIG. 12) aligned generally along the second axis 122. The second configuration 500 may be perpendicular or otherwise transverse to the first configuration 400. In such embodiments, the first and second generally rectangular aperture portions of the receiving aperture 114 may have the same or different widths or lengths. For example, one aperture portion may be sized to receive a relatively narrow accessory dimension, while another aperture portion may be sized to receive a relatively wider accessory dimension. This may permit the same one or more inserts 112 to accommodate different accessories, different magazine orientations, or different user preferences by changing the orientation of the accessory relative to the receiving aperture 114.

The retaining protrusions 136 may generally include projections, ridges, tabs, keys, bosses, ears, rails, lugs, barbs, detents, or other structures extending from one or more sides of the one or more inserts 112. In the illustrated embodiment, one or more retaining protrusions 136 extend outwardly from side surfaces of the one or more inserts 112 and are configured to be received in corresponding retaining openings or one or more insert-receiving openings 110 of the container body 102. Although the same reference numeral may be used in the drawings for related retaining features, the retaining protrusions 136 of the one or more inserts 112 may cooperate with corresponding retaining openings or seats of the container body 102 to resist removal of the one or more inserts 112 from the container body 102. The retaining protrusions 136 may extend laterally beyond an outer surface of the first insert portion 132, the second insert portion 134, or both so that the retaining protrusions 136 pass into, through, behind, or beyond a wall portion of the container body 102 when the one or more inserts 112 is seated.

The retaining protrusions 136 may be positioned on any side of the one or more inserts 112. In certain embodiments, the one or more inserts 112 includes retaining protrusions 136 on at least two sides of the one or more inserts 112. The at least two sides may be opposing sides, adjacent sides, or nonparallel sides. Providing retaining protrusions 136 on adjacent sides may allow the one or more inserts 112 to be seated in the container body 102 in a first rotational orientation and also in a second rotational orientation rotated, for example, about ninety degrees relative to the first rotational orientation, while still allowing at least two retaining protrusions 136 to engage corresponding portions of the container body 102. This rotationally adaptable configuration may allow the same one or more inserts 112 to be used in different orientations to accommodate different accessories or accessory orientations without changing the container body 102.

The retaining protrusions 136 may interact with the container body 102 by compressing, deflecting, snapping, or otherwise moving relative to the one or more insert-receiving openings 110 during installation of the one or more inserts 112. For example, the retaining protrusions 136 may have sufficient flexibility or resiliency to compress inwardly as the one or more inserts 112 is pressed into the one or more insert-receiving openings 110 and then expand, rebound, or return toward an undeformed, preformed position after passing a wall edge, lip, shoulder, or corresponding retaining opening of the container body 102. Once seated, the retaining protrusions 136 may resist upward removal, lateral shifting, rotation, peeling, or dislodgment of the one or more inserts 112 relative to the container body 102. This is particularly useful when the one or more inserts 112 frictionally grips a firearm magazine 130 or other accessory, because withdrawal of the accessory may otherwise tend to pull the one or more inserts 112 out of the container body 102. The retaining protrusions 136 therefore improve over prior liners or foam inserts that rely solely on adhesive or friction and may become dislodged during repeated use.

The retaining protrusions 136 may have different geometries depending on the intended retention mechanism. For example, the retaining protrusions 136 may be continuous ridges extending along a side of the one or more inserts 112, discrete tabs spaced along a side of the one or more inserts 112, wedge-shaped protrusions, rounded protrusions, hooked protrusions, undercut protrusions, compressible ribs, dovetail-like protrusions, snap-fit detents, or combinations thereof. In some embodiments, the retaining protrusions 136 may be integrally formed with the one or more inserts 112. In other embodiments, the retaining protrusions 136 may be attached to the one or more inserts 112, overmolded onto the one or more inserts 112, inserted into the one or more inserts 112, bonded to the one or more inserts 112, or formed as part of a separate carrier coupled to the one or more inserts 112. The retaining protrusions 136 may be formed from the same material as the one or more inserts 112 or from a different material having a different stiffness, hardness, coefficient of friction, wear resistance, or elastic recovery.

The one or more inserts 112 may be formed from one or more resilient, compressible, flexible, semi-rigid, or rigid materials. In some embodiments, at least the portion of the one or more inserts 112 surrounding the receiving aperture 114 is resilient so that the tapered wall portions 124, narrowed waist regions 126, and further compression protrusions 140 may elastically deflect during insertion or withdrawal of an accessory. Suitable materials may include foam, closed-cell foam, open-cell foam, rubber, silicone, urethane, thermoplastic elastomer, resilient polymer, elastomeric composite, cork, felt, layered polymeric material, additively manufactured lattice material, or combinations thereof. In other embodiments, the one or more inserts 112 may include a harder outer portion and a softer inner aperture-facing portion, or may include coatings, liners, sleeves, films, or overmolded regions selected to provide a desired friction, durability, or cushioning characteristic.

The one or more inserts 112 may be made by cutting, die-cutting, molding, injection molding, compression molding, casting, machining, waterjet cutting, laser cutting, additive manufacturing, laminating, bonding, overmolding, or combinations thereof. In embodiments having the first insert portion 132 and the second insert portion 134, the portions may be manufactured separately and then joined, or may be formed together in a single manufacturing operation. In embodiments having first insert portions 132 that are interchangeable, different aperture profiles may be produced and selectively coupled to a common second insert portion 134. This may reduce manufacturing cost, inventory complexity, or user replacement cost, because the portion that interfaces with the accessory may be changed without replacing the firearm magazine holder assembly 100 entirely.

The one or more inserts 112 and the receiving aperture 114 are not limited to use with firearm magazines or firearm accessories. In other embodiments, the receiving aperture 114 may be sized, shaped, contoured, or otherwise configured to receive and retain tools, flashlights, batteries, medical devices, electronic devices, writing instruments, knives, multitools, personal-defense accessories, cylindrical articles, rectangular articles, irregularly shaped articles, or other objects suitable for organized storage. The receiving aperture 114 may therefore include a circular, oval, rectangular, polygonal, cruciform, keyed, tapered, stepped, slotted, compound, or irregular profile selected based on the exterior geometry of the article to be retained. In some embodiments, the same one or more inserts 112 may receive different types of articles in different orientations, while in other embodiments different inserts 112 may be provided with different receiving apertures 114 for different article types. Accordingly, although certain embodiments are described with reference to firearm magazines 130, the structure and operation of the one or more inserts 112 may be applied more broadly to retain accessories or objects in a storage location.

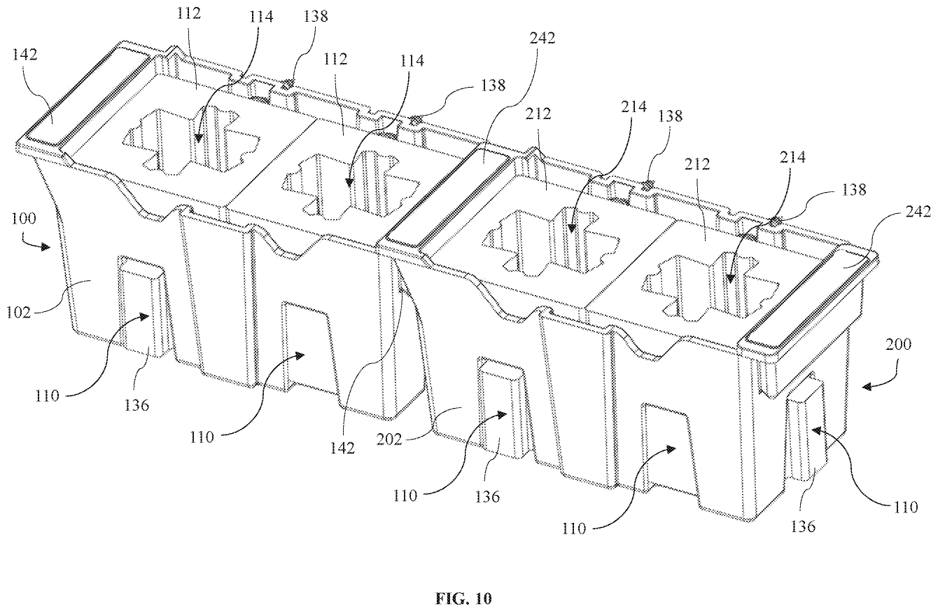

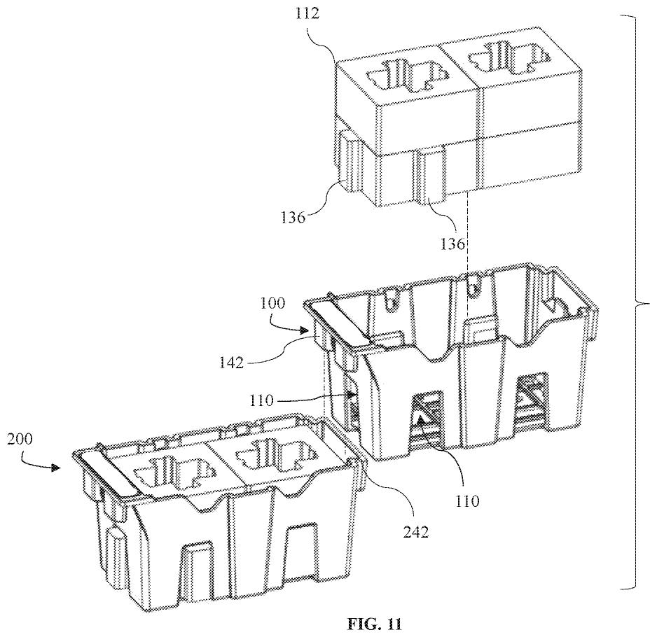

Referring now to FIGS. 10-12, a modular firearm accessory holder system is shown according to an example embodiment. The modular firearm accessory holder system may include the firearm magazine holder assembly 100 and an adjacent second container body 200 coupled to the firearm magazine holder assembly 100. The adjacent second container body 200 may be the same as, substantially similar to, or different from the container body 102. For example, the adjacent second container body 200 may include one or more features corresponding to the bottom wall 104, plurality of sidewalls 106, open upper side 108, one or more insert-receiving openings 110, inserts 112, receiving apertures 114, retaining protrusions 136, fasteners 138, connectors 142, end portions 144, compression pads 146, or combinations thereof. In this manner, the system may be expanded from a single holder assembly into a multi-module arrangement configured to hold multiple firearm magazines, firearm accessories, or other articles in a selected storage location.

As shown in FIG. 10, the adjacent second container body 200 may include a second container body wall structure 202 and one or more second inserts 212 supported by the adjacent second container body 200. Each of the one or more second inserts 212 may include a second receiving aperture 214 configured to receive a firearm magazine, firearm accessory, tool, or other article. The one or more second inserts 212 and second receiving aperture 214 may be configured similarly to the one or more inserts 112 and receiving aperture 114, or may have a different profile, size, material, compression characteristic, depth, or orientation. For example, the second receiving aperture 214 may be configured to receive a different accessory than the receiving aperture 114, or may be configured to receive the same type of accessory in a different orientation. This allows a user to configure a single modular system to hold different magazine types, accessories, or article sizes without requiring each container body to have identical inserts.

As shown in FIGS. 10 and 11, the container body 102 and the adjacent second container body 200 may be coupled by engagement between the connector 142 of the container body 102 and a second connector 242 of the adjacent second container body 200. The second connector 242 may generally define a complementary mechanical interlock configured to mate with the connector 142. In one embodiment, the connector 142 and the second connector 242 may include complementary dovetail profiles. In one example embodiment, the second connector 242 may define the complementary dovetail profile, and the connector 142 may slidably engage the second connector 242 to couple the container body 102 to the adjacent second container body 200. In other embodiments, the connector 142 and the second connector 242 may include complementary channel-and-projection features, rail-and-slot features, tongue-and-groove features, hook-and-recess features, snap-fit features, keyed profiles, undercut profiles, friction-fit profiles, magnetic coupling portions, fastener-coupled portions, or other mechanical coupling structures. The connector 142 and second connector 242 may allow adjacent modules to resist lateral separation, maintain relative alignment, and reduce independent movement of the modules within the storage location.

In the exploded configuration shown in FIG. 11, the one or more inserts 112 may be installed relative to the container body 102 by lowering, pressing, sliding, snapping, or otherwise seating the one or more inserts 112 into the container body 102. The retaining protrusions 136 of the one or more inserts 112 may engage one or more insert-receiving openings 110, retaining openings, shoulders, lips, or recesses of the container body 102. During installation, the retaining protrusions 136 may flex, compress, or deflect to pass through or beyond the corresponding openings or wall portions of the container body 102. After installation, the retaining protrusions 136 may expand or return toward an undeformed state to resist lifting or withdrawal of the one or more inserts 112 from the container body 102. This arrangement may be particularly advantageous where the receiving aperture 114 provides frictional or compressive engagement with an accessory, because removal of the accessory may otherwise tend to pull the one or more inserts 112 out of the container body 102.

As further shown in FIG. 11, the container body 102 may be joined to the adjacent second container body 200 before, during, or after installation of the one or more inserts 112. In some embodiments, the connector 142 may be slidably received by, lowered into, snapped into, or otherwise mechanically engaged with the second connector 242. The connector 142 and second connector 242 may be arranged so that the bottom wall 104 of the container body 102 and a corresponding bottom wall of the adjacent second container body 200 rest substantially flush with one another or against a common support surface. This permits the modular system to be placed in a storage compartment with reduced rocking, tilting, or uneven loading. In certain embodiments, one of the connector 142 or second connector 242 may define an upwardly open receptacle or channel, and the other may define a downwardly extending interlock projection received by the receptacle or channel. Such a configuration may allow adjacent modules to be assembled vertically while maintaining lateral retention after assembly.

As shown in FIG. 12, the modular firearm accessory holder system may be positioned within a secondary wall member 300, such as a vehicle door pocket, in a fully assembled configuration. The secondary wall member 300 may generally define any wall, compartment, recess, tray, drawer, safe wall, lockbox wall, cabinet wall, console wall, vehicle storage wall, or other support structure configured to receive or support the system. In the illustrated embodiment, the secondary wall member 300 is a vehicle door pocket; however, the same modular system may be positioned in other storage locations. The container body 102 and adjacent second container body 200 may cooperate to provide a modular holder that spans a portion of the secondary wall member 300 while maintaining separate receiving locations for accessories.

The modular arrangement shown in FIG. 12 may receive an accessory in a first configuration 400 and an accessory in a second configuration 500. The first configuration 400 and the second configuration 500 may represent different orientations of the same accessory, different accessories, different magazine sizes, or different cross-sectional profiles received by corresponding receiving apertures 114, 214. In one embodiment, the second configuration 500 may be rotated relative to the first configuration 400, including by about ninety degrees. The receiving apertures 114, 214 may therefore allow different accessories or differently oriented accessories to be retained in the same modular holder system. This may improve over fixed rigid organizers by allowing a user to tailor accessory orientation, spacing, and arrangement to the available storage space and intended use.

The modular firearm accessory holder system may improve over prior storage arrangements by allowing a user to selectively add, remove, replace, or reorient container bodies and inserts. For example, a user may couple one container body 102 to one adjacent second container body 200 for a smaller storage space, or may couple multiple adjacent container bodies to form a longer array for a larger compartment. In some embodiments, one module may include inserts configured for firearm magazines, while another module may include inserts configured for tools, flashlights, batteries, medical components, or other articles. The mechanical interlock between modules may maintain the modules in a stable relationship while still permitting the system to be reconfigured without permanent modification of the storage location.

The container body 102, adjacent second container body 200, inserts 112, one or more second inserts 212, connector 142, and second connector 242 may be formed from any of the materials and by any of the manufacturing methods described herein. In some embodiments, the container bodies may be molded or printed as rigid or semi-rigid components, while the inserts may be formed from resilient foam or elastomeric materials. In other embodiments, the container bodies may include resilient or compressible exterior portions, such as compression pads 146, configured to frictionally engage the secondary wall member 300. The material selection may be based on the intended storage environment, desired durability, desired compression force, desired modularity, and the type of accessory to be retained.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A firearm magazine holder assembly comprising:
a container body sized for placement in a vehicle door pocket, the container body comprising a bottom wall, a plurality of sidewalls extending upwardly from the bottom wall, and an open upper side;
an insert-receiving opening disposed along at least one sidewall of the plurality of sidewalls of the container body; and
a resilient insert seated in the insert-receiving opening, wherein the resilient insert comprises a receiving aperture;
wherein the receiving aperture comprises a central region and a plurality of lobes extending outwardly from the central region.

2. The firearm magazine holder assembly of claim 1, wherein the receiving aperture has a generally cruciform profile.

3. The firearm magazine holder assembly of claim 2, wherein the plurality of lobes comprises a first pair of opposed lobes extending along a first axis and a second pair of opposed lobes extending along a second axis transverse to the first axis.

4. The firearm magazine holder assembly of claim 3, wherein adjacent lobes are separated by tapered wall portions extending inwardly toward the central region.

5. The firearm magazine holder assembly of claim 4, wherein the tapered wall portions define narrowed waist regions between adjacent lobes.

6. The firearm magazine holder assembly of claim 5, wherein the narrowed waist regions are positioned to contact exterior surfaces of an ammunition magazine received in the receiving aperture.

7. The firearm magazine holder assembly of claim 6, wherein the narrowed waist regions define a plurality of spaced compression regions around the ammunition magazine.

8. The firearm magazine holder assembly of claim 7, wherein the resilient insert elastically deflects at the plurality of spaced compression regions when the ammunition magazine is received in the receiving aperture.

9. The firearm magazine holder assembly of claim 8, wherein at least one sidewall of the plurality of sidewalls comprises a connector.

10. The firearm magazine holder assembly of claim 9, wherein the connector is defined by an end portion of the container body that includes a dovetail profile configured to slidably engage a second connector that is a complementary dovetail profile of an adjacent container body to couple the container body to the adjacent container body.

11. A firearm magazine retention insert system comprising:
a container;
an insert disposed in the container;
a retaining protrusion extending from a side of the insert; and
a retaining opening formed in the container below an upper wall portion,
wherein the retaining protrusion is received in the retaining opening to resist removal of the insert from the container when a firearm magazine is withdrawn from the insert.

12. The firearm magazine retention insert system of claim 11, wherein the insert comprises a first insert portion disposed proximate to a second insert portion, wherein at least one of the first insert portion and the second insert portion comprises the retaining protrusion, and wherein at least one of the first insert portion and the second insert portion comprises a receiving section extending therein.

13. The firearm magazine retention insert system of claim 11, wherein the insert comprises a receiving aperture having a generally cruciform cross-sectional profile.

14. The firearm magazine retention insert system of claim 11, wherein the insert comprises a receiving aperture having a generally cruciform cross-sectional profile defined by a plurality of wall portions that taper toward a central region.

15. The firearm magazine retention insert system of claim 11 further comprising a connector defined by an end portion of the container that includes a dovetail profile configured to slidably engage a complementary dovetail profile of an adjacent second container to couple the container to the adjacent second container.

16. The firearm magazine retention insert system of claim 11, wherein the insert comprises a receiving aperture having at least a generally rectangular cross-sectional profile portion.

17. The firearm magazine retention insert system of claim 11, wherein the insert comprises a receiving aperture having at least a generally rectangular cross-sectional profile portion defined by opposing lobes that have tapered wall portions extending inwardly toward a central region of the generally rectangular cross-sectional profile portion.

18. The firearm magazine retention insert system of claim 11 further comprising a fastener attaching the container to a secondary wall member in an assembled configuration.

19. A modular firearm accessory holder system comprising:
a container body comprising a bottom wall, a plurality of sidewalls extending upwardly from the bottom wall, and an open upper side;
an insert seated in the container body, the insert comprising an accessory-receiving aperture configured to receive a firearm accessory, the accessory-receiving aperture comprising a central region, a plurality of lobes extending outwardly from the central region, and a plurality of protrusions projecting inwardly relative to the accessory-receiving aperture;
a retaining protrusion extending from a sidewall of the insert;
a retaining opening formed in at least one sidewall of the plurality of sidewalls of the container body, wherein the retaining protrusion is received in the retaining opening to resist removal of the insert from the container body when the firearm accessory is withdrawn from the accessory-receiving aperture; and
a connector at an end portion of the container body, the connector including a first mechanical interlock configured to mate with a complementary second mechanical interlock of an adjacent second container body to couple the container body to the adjacent second container body.

20. The modular firearm accessory holder system of claim 19, further comprising:
the adjacent second container body comprising a bottom wall, a plurality of sidewalls extending upwardly from the bottom wall, and an open upper side;
a second insert seated in the adjacent second container body, the second insert comprising a second accessory-receiving aperture; and
a second connector at an end portion of the adjacent second container body, the second connector defining the complementary second mechanical interlock.
